(19) United States
(12) Patent Application Publication
(10) Pub. No.: US 2019/0099326 A1
(43) Pub. Date: Apr. 4, 2019

(54) Pedicure Sink, System and Method

(71) Applicant: Tri Huu Pham, Sugar Land, TX (US)

(72) Inventor: Tri Huu Pham, Sugar Land, TX (US)

(21) Appl. No.: 16/145,004

(22) Filed: Sep. 27, 2018

Related U.S. Application Data
(60) Provisional application No. 62/537,927, filed on Jul. 27, 2017.

(51) Int. Cl. A61H 35/00; A47K 3/022

(52) U.S. Cl. CPC A61H 35/006; A47K 3/10; A47K 3/022

(57) ABSTRACT

The present application is directed to a portable sink that may be used as a pedicure sink usable alone or as part of a pedicure spa or other furniture. The pedicure sink includes a basin and a surface extending out from the basin that is operationally configured to support feet thereon and capture fluid and direct fluid into the basin.

### CROSS-REFERENCE TO RELATED APPLICATIONS

This application claims benefit of U.S. Provisional Patent Application Ser. No. 62/537,927, filed on Jul. 27, 2017, the content of which is hereby incorporated by reference in its entirety.

### STATEMENT REGARDING FEDERALLY SPONSORED RESEARCH OR DEVELOPMENT

Not applicable.

### FIELD OF THE INVENTION

The application relates generally to a sink used in the pedicure industry.

### BACKGROUND OF THE INVENTION

One common style of pedicure spa currently used in pedicure businesses includes a main body for supporting a chair, a water basin and a foot rest, e.g., a single foot rest for both feet of a person sitting in the chair, or individual foot rests for each of the left and right feet. As shown in FIGS. 1A-1C, this style of pedicure spa includes a foot rest that is separate from the water basin. Such a configuration results in fluid run-off from the foot rest onto at least part of the main body of the pedicure spa via gravity. In commercial operation, the main body has to be periodically cleaned to remove fluid run-off, which typically includes water as well as chemicals used in the pedicure process. Preventing fluid run-off is desirable.

### SUMMARY OF THE INVENTION

The present application is directed to a pedicure sink including a basin having a fluid flow surface extending from within the basin out apart from the basin in a continuous manner, wherein at least part of the fluid flow surface provides a support surface for target feet.

The present application is also directed to a pedicure sink, including (1) a basin defined by an upper perimeter; and (2) a target feet support surface extending out from the basin in a manner effective to direct fluid collected thereon into the basin via gravity, wherein the target feet support surface is located at an elevation greater than the upper perimeter of the basin.

The present application is also directed to a pedicure spa including a pedicure sink and a body operationally configured to support the pedicure sink thereon, wherein the pedicure sink includes a basin having a fluid flow surface extending from within the basin out apart from the basin in a continuous manner, wherein at least part of the fluid flow surface provides a support surface for target feet.

### BRIEF DESCRIPTION OF THE SEVERAL VIEWS OF THE DRAWING

FIG. 1A is a perspective view of an embodiment of a prior art pedicure spa.

FIG. 1B is a perspective view of an embodiment of a prior art pedicure spa.

FIG. 1C is a perspective view of an embodiment of a prior art pedicure spa.

FIG. 2 is a side perspective view of a simplified embodiment of a pedicure sink of this application.

FIG. 3A is a side view of a simplified embodiment of a pedicure sink of this application.

FIG. 3B is a front perspective view of the pedicure sink of FIG. 3A.

FIG. 4 is a top view of a simplified embodiment of a pedicure sink of this application.

FIG. 5 is a side perspective view of a simplified embodiment of a pedicure sink of this application.

FIG. 6 is a side perspective view of a simplified embodiment of a pedicure sink of this application.

FIG. 7 is a rear view of a simplified embodiment of a pedicure sink of this application.

FIG. 8 is a rear view of a simplified embodiment of a pedicure sink of this application.

FIG. 9 is a side view of a simplified embodiment of a pedicure sink of this application.

FIG. 10 is a front perspective view of a simplified embodiment of a pedicure sink of this application.

FIG. 11 is a rear perspective view of a simplified embodiment of a support member of this application.

FIG. 12A is a front perspective view of a simplified embodiment of a pedicure spa of this application.

FIG. 12B is a front perspective view of a simplified embodiment of a pedicure spa of this application including a sink and absent a chair used by pedicure customers.

FIG. 12C is a front perspective view of a simplified embodiment of a pedicure spa of this application including a sink and absent a chair used by pedicure customers.

FIG. 13 is a bottom view of a simplified embodiment of a pedicure sink of this application.

FIG. 14 is a top view of a simplified embodiment of a pedicure sink of this application.

FIG. 15 is a rear view of a simplified embodiment of a pedicure sink of this application.

FIG. 16 is a front view of a simplified embodiment of a pedicure sink of this application.

FIG. 17 is a side view of a simplified embodiment of a pedicure sink of this application.

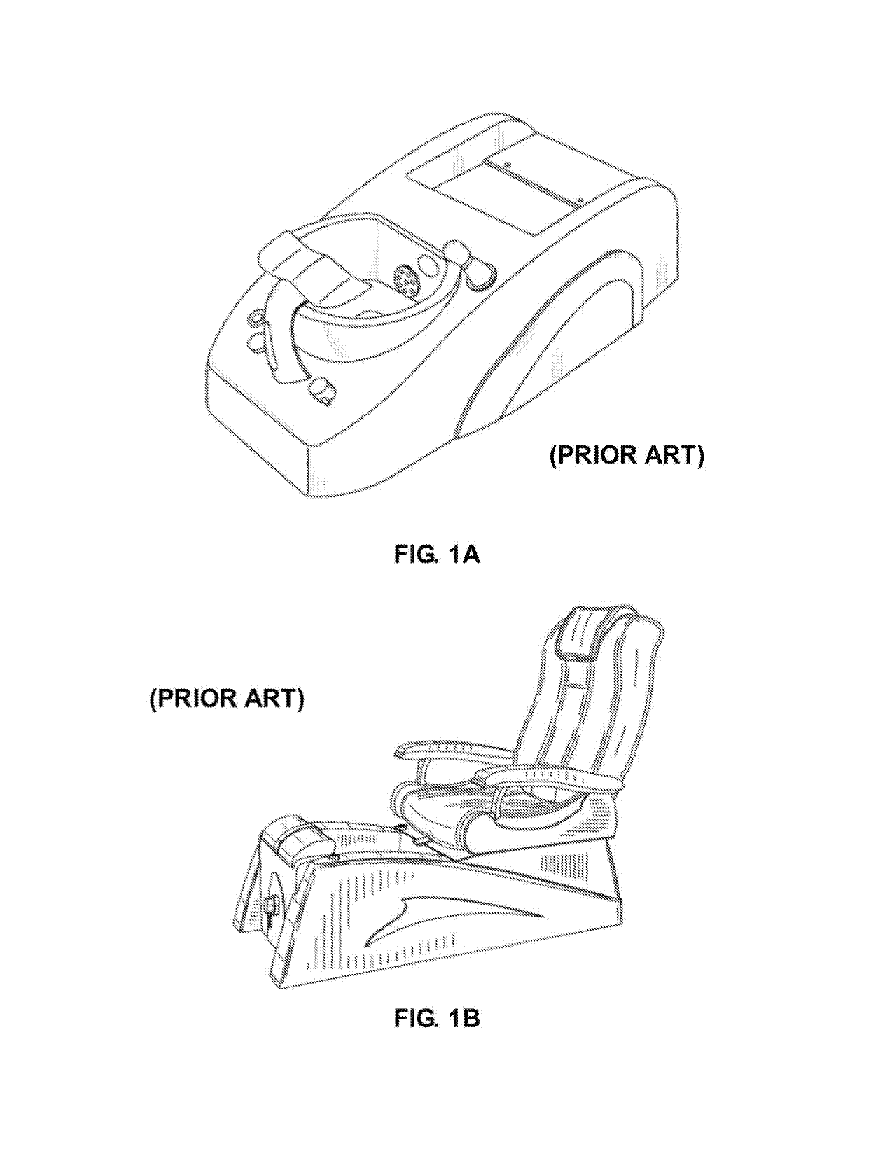

### DETAILED DESCRIPTION OF THE INVENTION

Before describing the invention in detail, it is to be understood that the present pedicure sink, system and method are not limited to particular embodiments. It is also to be understood that the terminology used herein is for the purpose of describing particular embodiments only, and is not intended to be limiting.

Approximating language, as used herein throughout the specification and claims, may be applied to modify any quantitative representation that could permissibly vary, without resulting in a change in the basic function to which it is related. Accordingly, a value modified by a term or terms, such as “about,” is not limited to the precise value specified. In some instances, the approximating language may correspond to the precision of an instrument for measuring the value. As used in this specification and claim(s), the term “about” is defined as being close to as understood by one of ordinary skill in the art, and in one non-limiting embodiment the term may be defined to be within 10%, suitably within 5%, more suitably within 1%, and most suitably within 0.5% of a particular numerical value. The terms “first,” “second,” and the like, herein do not denote any order, quantity, or importance, but rather are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable. For example, in some circumstances, an event or capacity can be expected, while in other circumstances, the event or capacity cannot occur. This distinction is captured by the terms “may” and “may be”, or “can” or “can be.”

As used in this specification and the appended claims, the phrase “target feet” refers to the one or more feet of individuals receiving foot treatments including, but not necessarily limited to foot cleaning, foot disinfecting, pedicures, foot massages, nail polish application, and combinations thereof. The phrases “customer feet” and “person's feet” may be used interchangeably with the phrase “target feet.” As understood by persons of ordinary skill in the art, the term “pedicure” may refer to one or more of the following activities: cutting, clipping and filing target feet toenails, polishing target feet toenails, exfoliating dead skin cells from target feet, moisturizing target feet skin, and massaging target feet. As understood by the skilled artisan, one typical type of pedicure commercially offered at the time of this application includes a “classic” or regular pedicure, which typically involves a warm foot soak and a foot scrubbing with either a pumice stone or foot file followed by clipping of the nails, shaping of the nails, the pushing back of cuticles, a short foot and calf massage, application of moisturizer to target feet and nail polish to the toe nails if desired. Commercially available pedicures include, but are not necessarily limited to the following types: (1) classic or regular pedicures, (2) French pedicures, (3) gel pedicures, (4) paraffin pedicures, (5) hot stone pedicures, (6) fish pedicures, (7) mini pedicures, (8) spa pedicures, (9) athletic pedicures, (10) spa pedicures, (11) margarita pedicures, (12) chocolate pedicures, (13) milk and honey pedicures, (14) wine pedicures, (15) ice cream pedicures, (16) salt pedicures and (17) rose pedicures.

In one aspect, the present application provides a pedicure sink including a foot rest surface operationally configured to receive fluid thereon and direct fluid into a basin of the pedicure sink. In another aspect, the application provides a pedicure spa including a pedicure sink with a foot rest surface operationally configured to receive and direct fluid into a basin of the pedicure sink. In one implementation, the basin may be large enough to for a person to soak his/her feet therein. The pedicure sink of this application is portable and may be removed from its corresponding pedicure spa for purposes of cleaning the pedicure sink as may be desired.

In another aspect, the application provides a pedicure sink including a basin and a foot support surface extending out from the basin in a manner effective to direct fluid from the foot support surface to the basin.

In another aspect, the application provides a pedicure sink with a basin and a foot support surface extending out from the basin, the inner surface of the basin and the surface of the foot support surface forming a continuous surface for unobstructed fluid flow from the foot support surface to within the basin. In other words, the present pedicure sink is operationally configured to allow unobstructed fluid flow from one or more elevations along the foot support surface outside the basin to a lower elevation within the basin. In another aspect, the present pedicure sink is operationally configured to allow unobstructed fluid flow from at least a first elevation along the foot support surface to at least a second lower elevation within the basin. In one embodiment, the continuous surface may be defined as a smooth surface.

In another aspect, the application provides a pedicure spa including a body operationally configured to support a pedicure sink thereon, the pedicure sink having a basin and a foot rest member extending out from the basin, wherein the foot rest member is operationally configured to receive fluid thereon and direct fluid into the basin, the body being operationally configured to support the foot rest member during operation. In another aspect, the present pedicure sink is operationally configured to prevent fluid flow from the foot rest member or surface of the foot rest member onto the outer surface of the body of the pedicure spa.

In another aspect, the application provides a pedicure sink including a basin having an inner surface that extends out in a continuous manner from within the basin to form a foot support surface of the pedicure sink. In other words, the inner surface of the basin and the foot support surface are operationally configured as a continuous surface.

In another aspect, the application provides a pedicure sink including a basin defined by an inner surface and an outer surface, the inner surface including a fluid collection surface extending out from the basin that is operationally configured to direct fluid received on its surface into the basin via gravity. At least part of the fluid collection surface external of the basin is operationally configured to provide a support surface for target feet of a user or customer of the pedicure sink.

In another aspect, the application provides a pedicure sink including a basin having a smooth fluid collection surface extending from within the basin out apart from the basin, wherein at least part of the fluid collection surface provides a support surface for target feet.

In another aspect, the application provides a pedicure sink including (1) a basin defined by an inner surface and an outer surface; and (2) wherein at least part of the inner surface includes an uninterrupted fluid collection surface defined by a midpoint extending out from the basin providing a support surface for target feet, the fluid collection surface being operationally configured to direct fluid received thereon to the basin via gravity.

In another aspect, the application provides a basin having an upper perimeter surface and a fluid collection surface extending out from the upper perimeter surface, the fluid collection surface being operationally configured to direct fluid received on its surface into the basin.

In another aspect, the application provides a basin having a fluid flow surface defined by a fluid collection surface, at least part of the inner surface of the basin and a transitional surface disposed between the fluid collection surface and the inner surface of the basin, the fluid collection surface being operationally configured to direct fluid received on its surface toward the transitional surface and into the basin along the inner surface of the basin.

In another aspect, the application provides a pedicure sink, including (1) a basin; and (2) a support surface for target feet for target feet, the support surface being operationally configured to receive fluid thereon and direct the fluid to the basin via gravity; wherein the basin is of a volume large enough to receive target feet therein.

In another aspect, the application provides a pedicure sink, including (1) a basin having an inner surface and outer surface; (2) a foot rest extending out from the outer surface of the basin, the foot rest having a foot support surface for target feet; (3) the pedicure sink having a transitional surface disposed between the inner surface of the basin and the foot support surface.

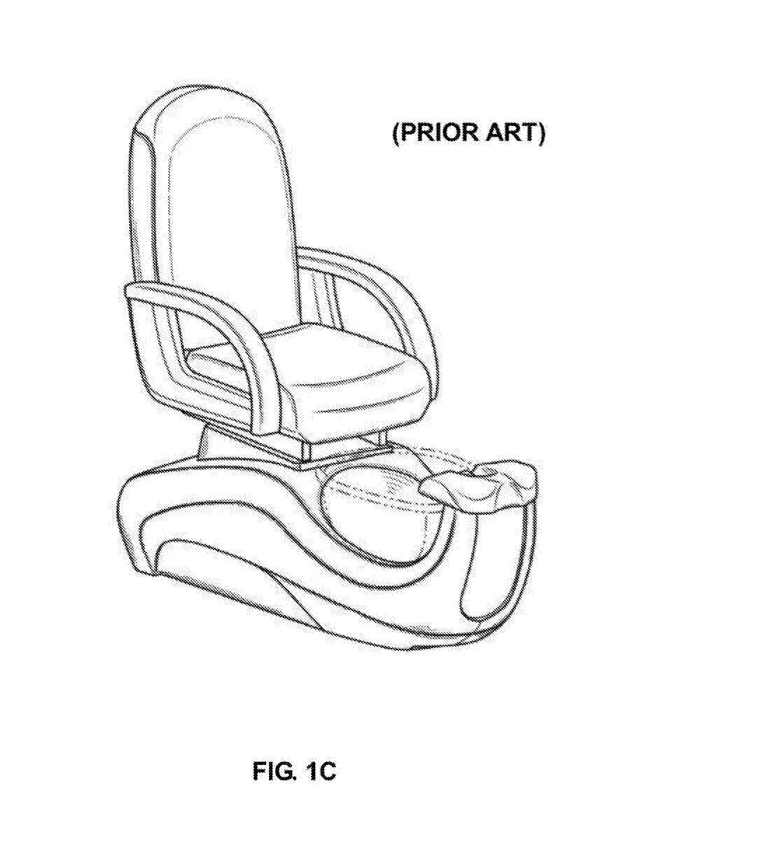

With reference now to FIG. 2, an exemplary pedicure sink (“sink 10”) of the present application is provided. As shown, the sink 10 suitably includes a fluid basin 12 of a particular volume and a foot rest member 13 extending out from the basin 12. In this embodiment, the shape of the outer surface 15 of the sink 10 and the inner surface 17 of the basin 12 may vary as desired. In addition, the outer surface 15 suitably comprises a front surface 20, a left side surface 22, a right side surface 23 and a rear surface 25 with radius corners 19. Likewise, the inner surface 17 comprises a four-wall surface with radius corners 18. Other outer surface 15 and inner surface 17 configurations are contemplated. For example, one suitable outer surface 15 and/or inner surface 17 may be curved, e.g., circular, oval. Another suitable outer surface 15 and/or inner surface 17 may be multi-sided, e.g., triangular, pentagonal, hexagonal, octagonal, etc., with corners of corresponding degrees.

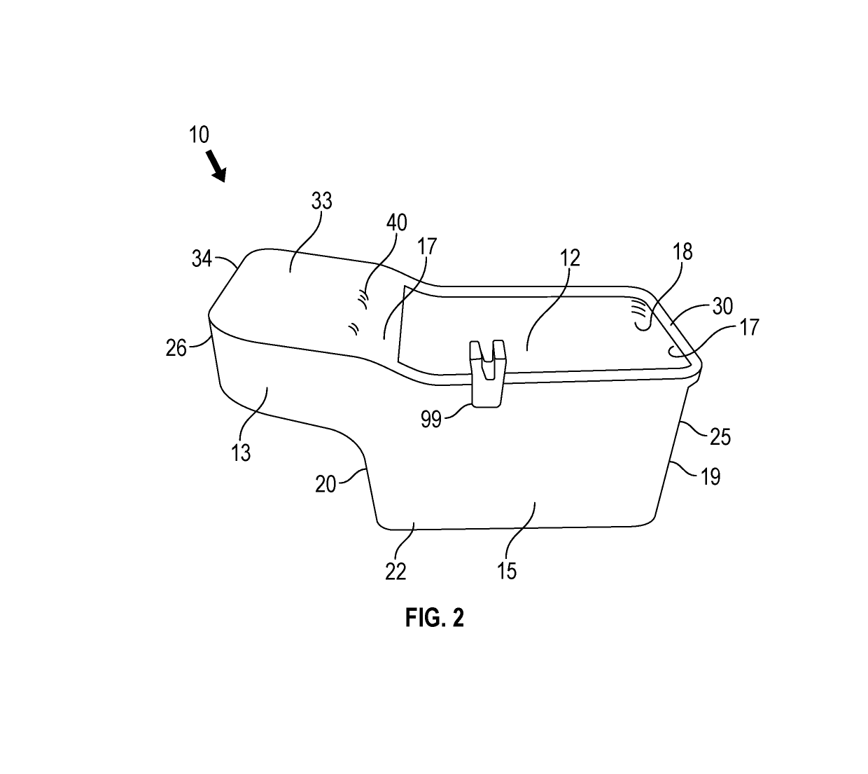

With reference to FIGS. 2 and 3, part of the sink 10 is defined by a first upper surface 30 governing the maximum fluid volume of the basin 12 and a second upper surface 33 forming the foot rest member 13. In this embodiment, the foot rest member 13 defines a front surface 26 and an uppermost part or uppermost surface of the sink 10. As shown, the second upper surface 33 suitably slopes from its uppermost edge or terminating portion 34 down to its intersection with the inner surface 17 of the basin 12. As such, the foot rest member 13 defines at least part of a fluid flow surface, operable as a fluid collection surface of the sink 10 effective for collection, delivery, or flow, of one or more fluids from the second upper surface 33 into the basin 12 via gravity.

A suitable fluid flow surface of the sink 10 is a continuous surface configuration extending from the uppermost edge 34 to the front inner surface 17 of the basin 12. In particular, the fluid flow surface includes the second upper surface 33, a forward part of the inner surface 17 and a transitional surface 40 interconnecting the lower most part of the second upper surface 33 and the forward part of the inner surface 17 of the basin 12. As shown in FIG. 2, the transitional surface 40 may be provided as an unobstructed surface allowing for fluid flow from the second upper surface 33 across the transitional surface 40 and the inner surface 17 into the basin 12.

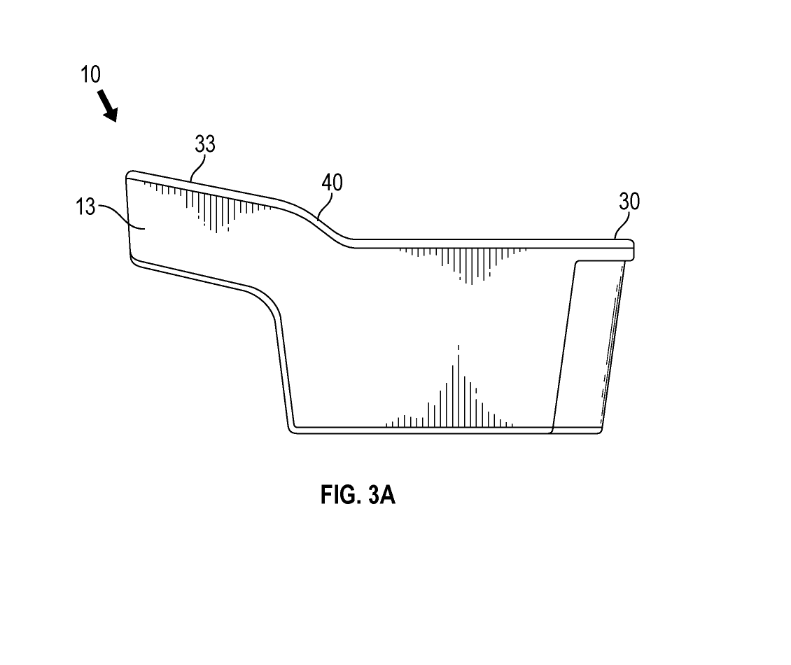

Turning to FIG. 4, a suitable fluid flow surface of the sink 10 may be defined by a midline 50, the fluid flow surface at the midline 50 being an unobstructed surface allowing for fluid flow from the second upper surface 33 into the basin 12 as described above. An unobstructed midline 50 also provides users of the sink 10, e.g., customers, with full use of an unobstructed second upper surface 33 and/or transitional surface 40 as a foot rest.

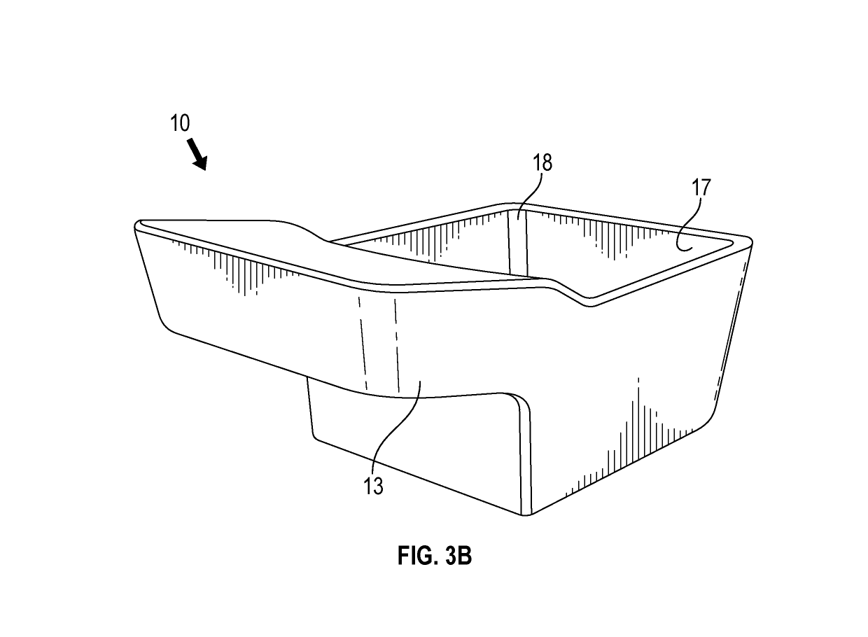

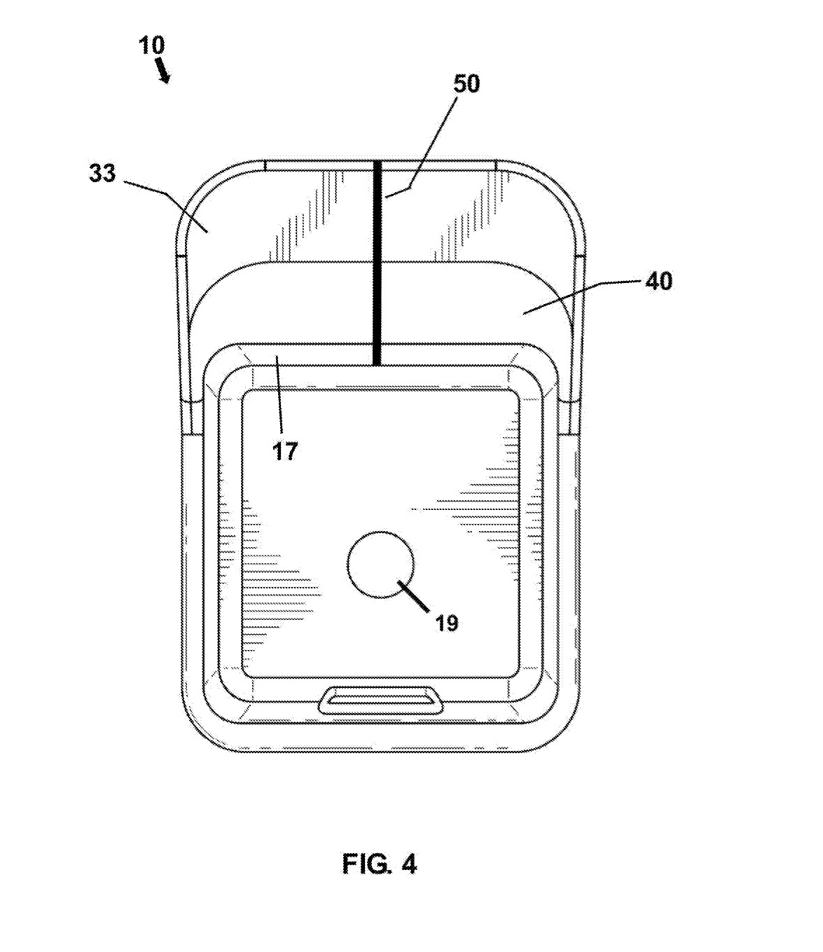

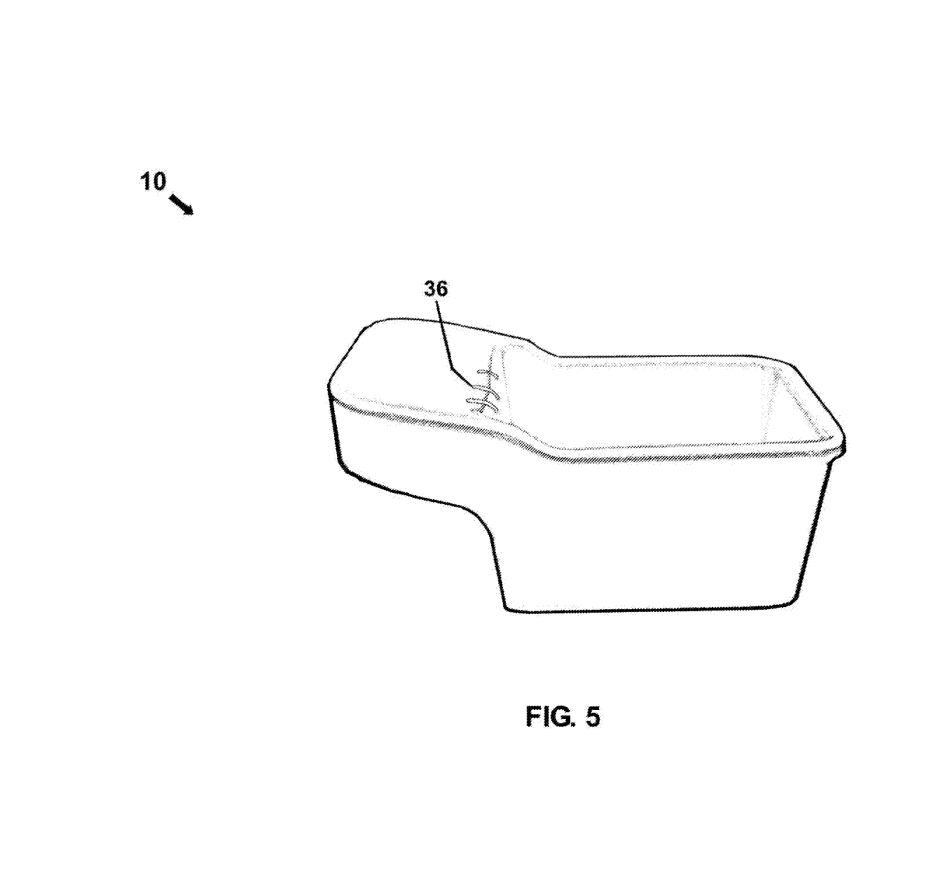

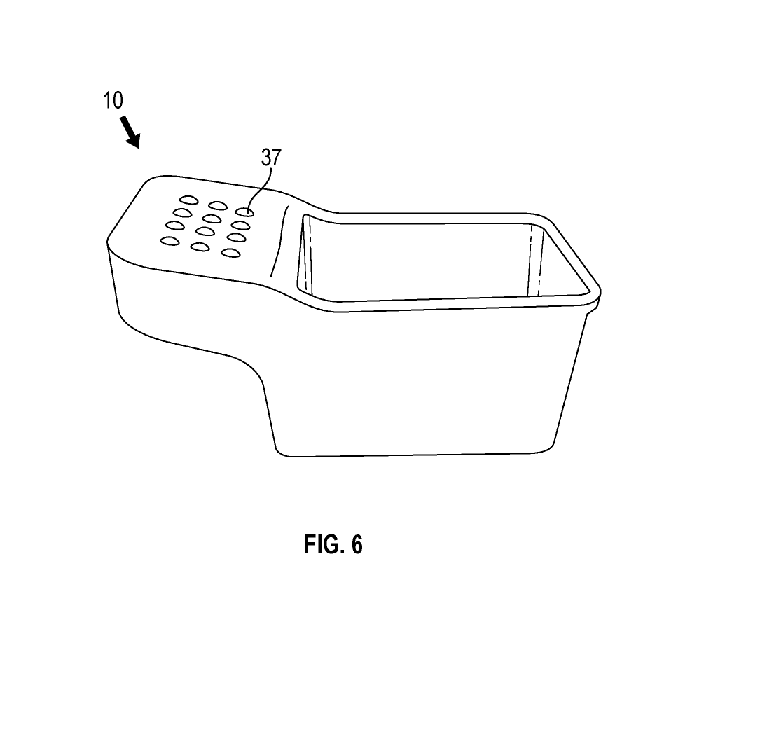

As shown, the second upper surface 33 of FIGS. 2-4 may be substantially planar providing a uniform foot rest surface. As shown in the embodiments of FIGS. 5 and 6, one or both of the second upper surface 33 and the transitional surface 40 may include one or more channels 36 of a desired depth and/or one or more raised surfaces 37 operationally configured to direct the flow path of fluid into the basin 12. The length and/or width and/or depth of the one or more channels 36 may be uniform or vary as desired. Likewise, the size and/or the height of the one or more raised surfaces 37 may be uniform or vary as desired. In another embodiment, the second upper surface 33 may be provided as a non-planar surface. For example, the second upper surface 33 may be provided in a U-shape or a V-shape forming an angle at the midline 50 as shown in FIG. 7. The second upper surface 33 may also be provided as a non-uniform surface as shown in the simplified illustration of FIG. 8.

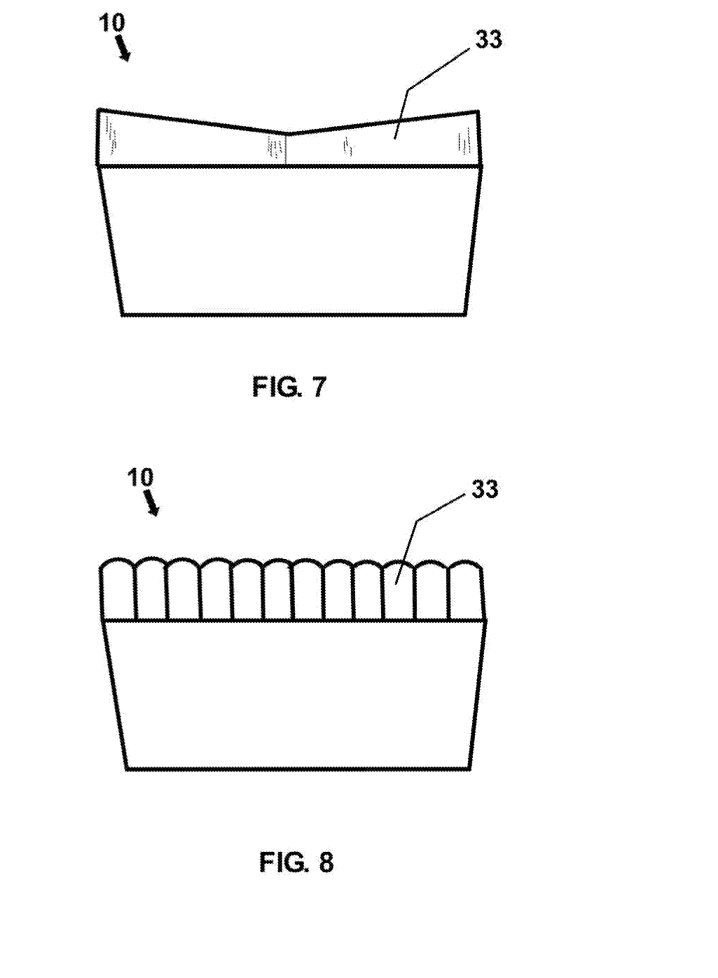

In still another embodiment, the lower most part of the second upper surface 33 may terminate at the inner surface 17 of the basin 12 as shown in the simplified view of FIG. 9. In such an embodiment void of a transitional surface 40, the fluid flow surface includes the second upper surface 33 alone or in combination with at least part of the inner surface 17.

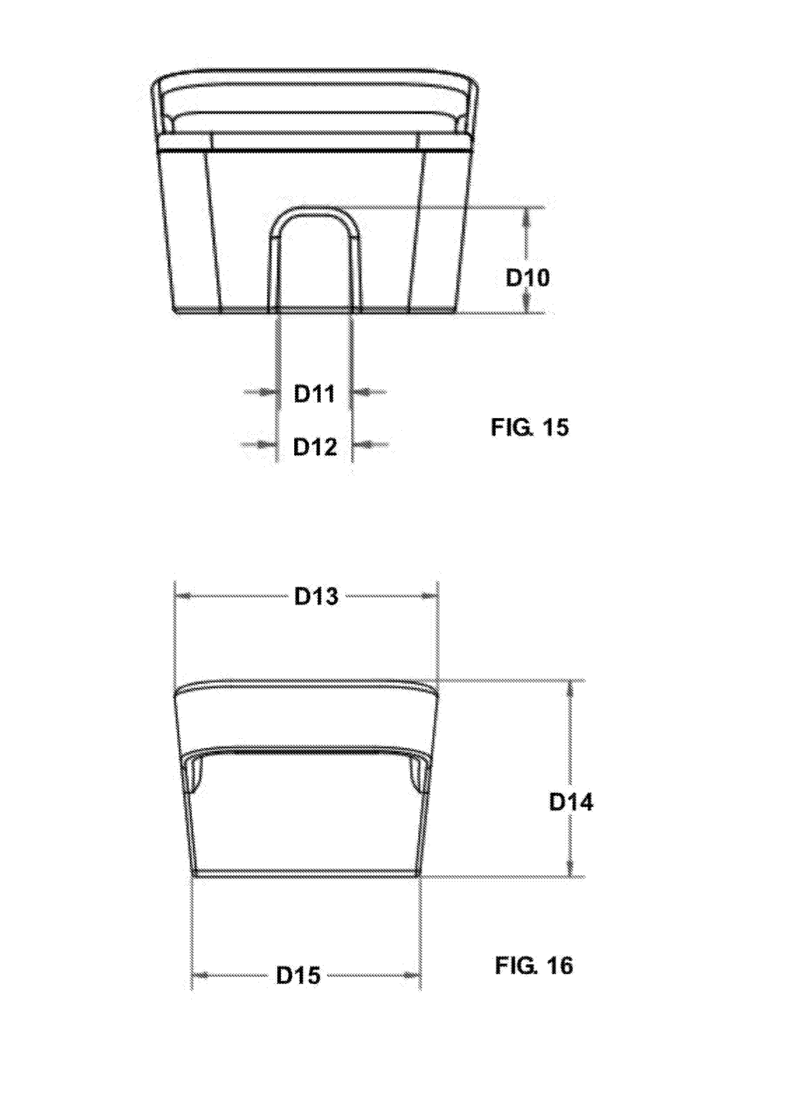

As stated above, the foot rest member 13 suitably extends out from the basin 12. Also, the construction of the sink 10 is effective to provide for standalone use of the sink 10 as desired. In one embodiment, the sink 10 may be provided as a solid member. In another embodiment, the bottom side of the foot rest member 13 may include a hollow cavity to minimize weight and/or manufacturing costs of the sink 10 (see FIG. 16).

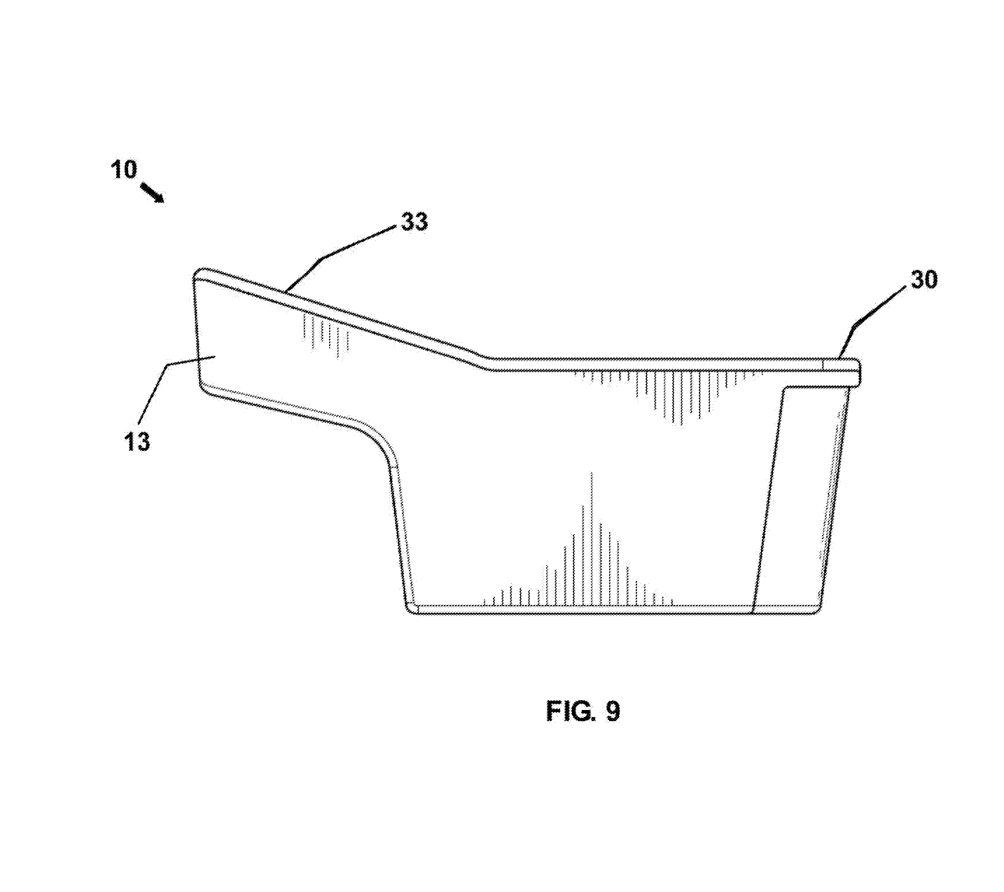

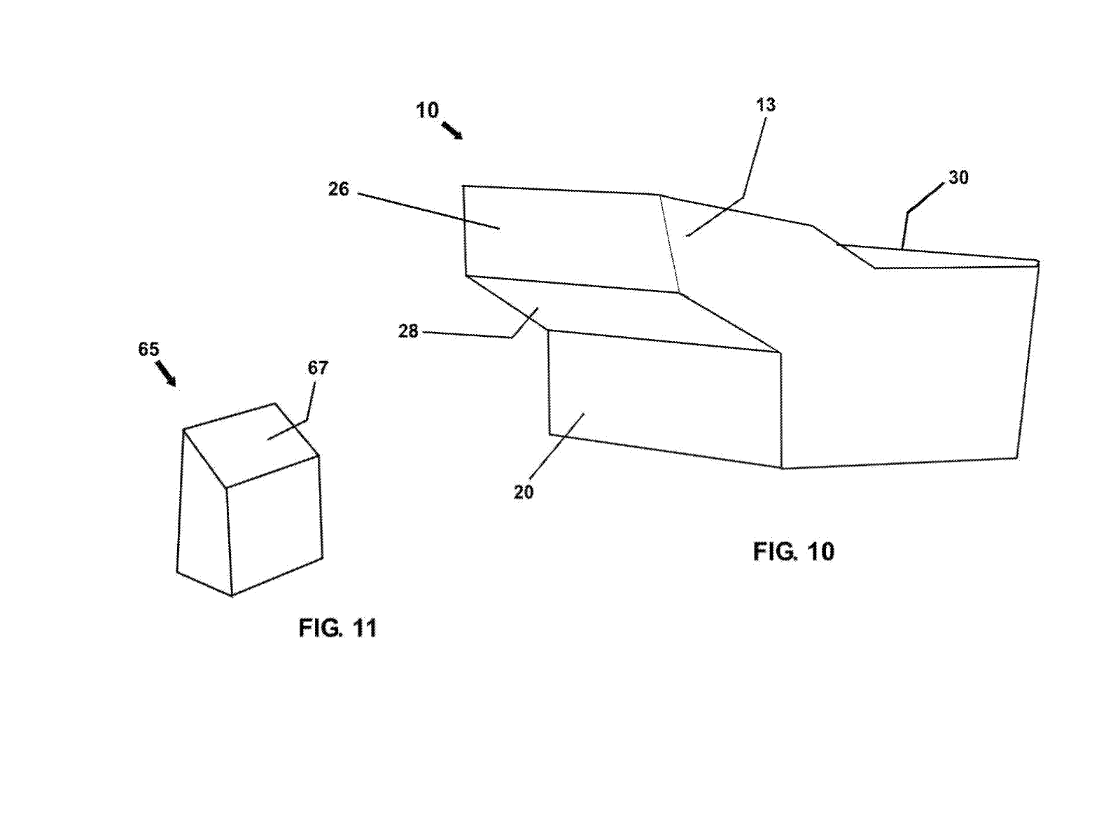

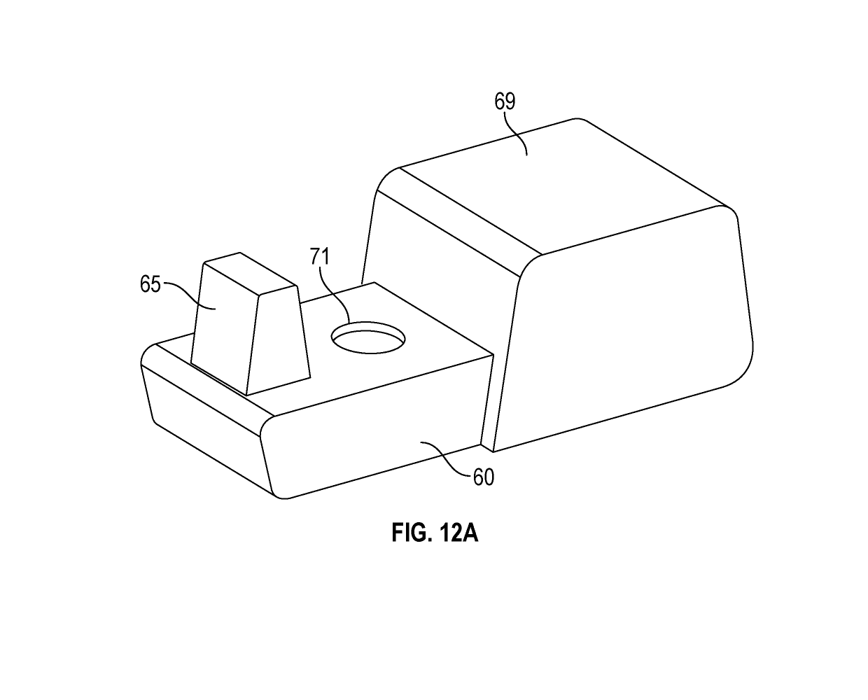

In another embodiment where the sink 10 is used as part of a pedicure spa supported on a spa body 60, the spa body 60 may include one or more support members 65 operationally configured to maintain the foot rest member 13 in a fixed position during operation, a chair support surface 69 and an opening 71 for draining the sink 10 via a drain 19 in fluid communication with plumbing disposed through the opening 71 (see FIGS. 10-12C). In one embodiment, one or more support members 65 may be load bearing members. In another embodiment, one or more support members 65 may be provided as non-load bearing members operationally configured to contact at least part of a bottom surface 28 of the foot rest member 13. Regardless of the type of support member(s) 65 provided, in a scenario where a customer applies a downward force to the second upper surface 33 with his/her feet, the one or more support members 65 are operationally configured to maintain the sink 10 in an operable fixed position, e.g., operationally configured to prevent the sink 10 from tilting forward.

One suitable bottom surface 28 may include a planar type surface as shown in FIG. 10. In such embodiment, the one or more support members 65 employed may include planar type surfaces contact surfaces 67 operationally configured to abut a bottom surface 28. Non-planar bottom surfaces 28 and/or contact surface 67 may be employed as desired for holding the sink 10 in an operable fixed position. In another embodiment, the bottom surface 28 may be inset in the form of a cavity like surface or the like for receiving at least part of a support member 65 in a mated position.

Without limiting the invention, a suitable sink 10 may be constructed of one or more materials durable enough to operate in pedicure operations. In particular, the sink 10 may be constructed of one or more materials including but not necessarily limited to those materials resistant to chipping, cracking, excessive bending and reshaping as a result of ozone, weathering, heat, moisture, other outside mechanical and chemical influences, as well as various impacts and other loads placed on the sink 10. Likewise, the sink 10 may comprise any color or combination of colors, or in the alternative, the sink 10 may be constructed from one or more transparent materials depending on individual preferences and needs.

Without limiting the invention, the sink 10 of this application may be constructed from materials, including, but not necessarily limited to plastics, rubbers, ceramics, cast iron, stainless steel, porcelain, one or more composite materials, thermoplastic, and combinations thereof. In one suitable embodiment, the sink 10 may include a solid surface material including, for example, a densified solid surface material made from a bio based resin with an ultraviolet (“UV”) stabilizer, alumina tri-hydrate and mineral fillers. The spa body 60 may also be constructed from one or more materials described in this paragraph in addition to one or more woods, bamboo, stone and combinations thereof.

In addition, the sink 10 may be constructed from one or more materials effective to retain heat, i.e., to retain the temperature of the fluid in the basin 12 of the sink 10 during use. In another embodiment, the sink 10 may be constructed from one or more materials effective to minimize the weight of the sink 10. Although the sink 10 may be built to scale and is not limited to any weight constraints, a suitable sink 10 weight may be about 22.68 kilograms or less (about 50.0 pounds or less). As appreciated by those skilled in the art, a heavier sink 10 may be used as desired.

In addition to water, the sink 10 may be used with any type of pedicure products known in the art. Common pedicure products include, but are not necessarily limited to surfactants, minerals, honey, herbal extracts, oils, essential oils, water based emulsions such as moisturizer lotions and creams, sugar crystals, salt crystals, pumice, polymer beads, finely ground nutshells, solvents such as alcohol (cetyl alcohol, stearyl alcohol), esters such as isopropyl palmitate, glyceryl stearate, humectants such as propylene glycol and glycerin, vitamins, silicones, nail polish, glues, menthol, and combinations thereof.

Although the sink 10 may be filled and emptied with fluid(s) manually, as stated above the sink 10 may include a drain 19 (see FIG. 4) in fluid communication with one or more plumbing fixtures via opening 71. It is also contemplated that the sink 10 be equipped with a faucet as understood by the skilled artisan. As shown in FIG. 2, the sink 10 may be provided with a removable sprayer head holder 99 or the like operationally configured to hold a separate water sprayer for use with the sink 10.

The invention will be better understood with reference to the following non-limiting example, which is illustrative only and not intended to limit the present invention to a particular embodiment.

### EXAMPLE 1

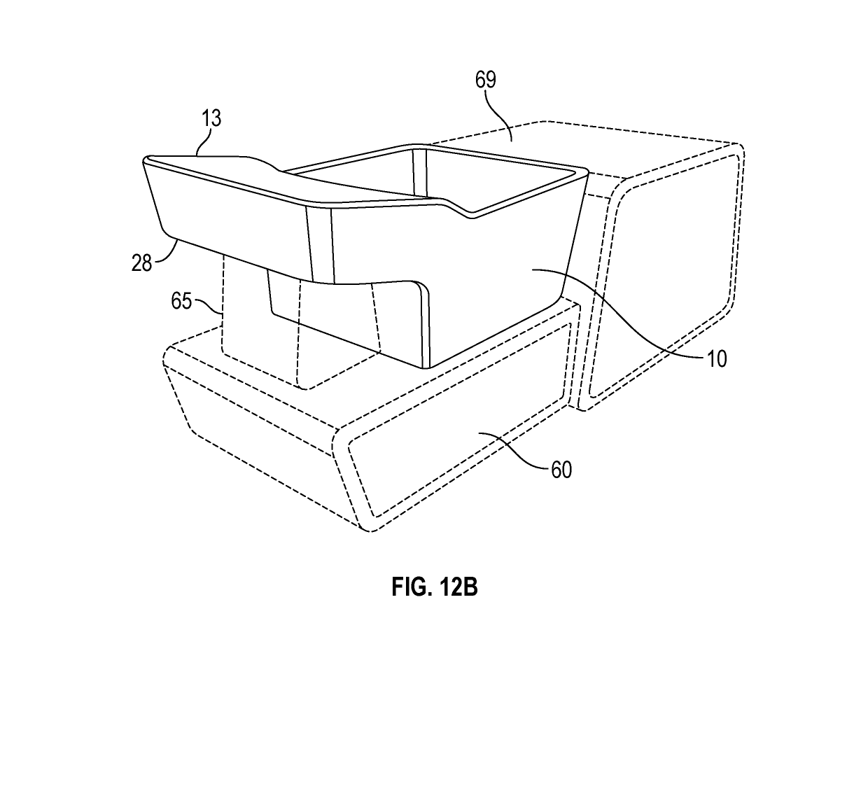

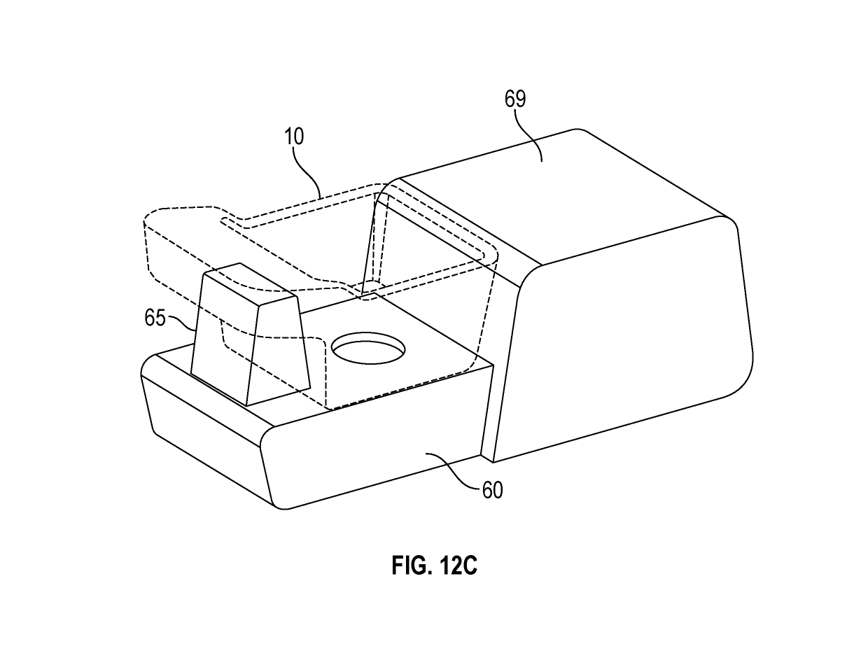

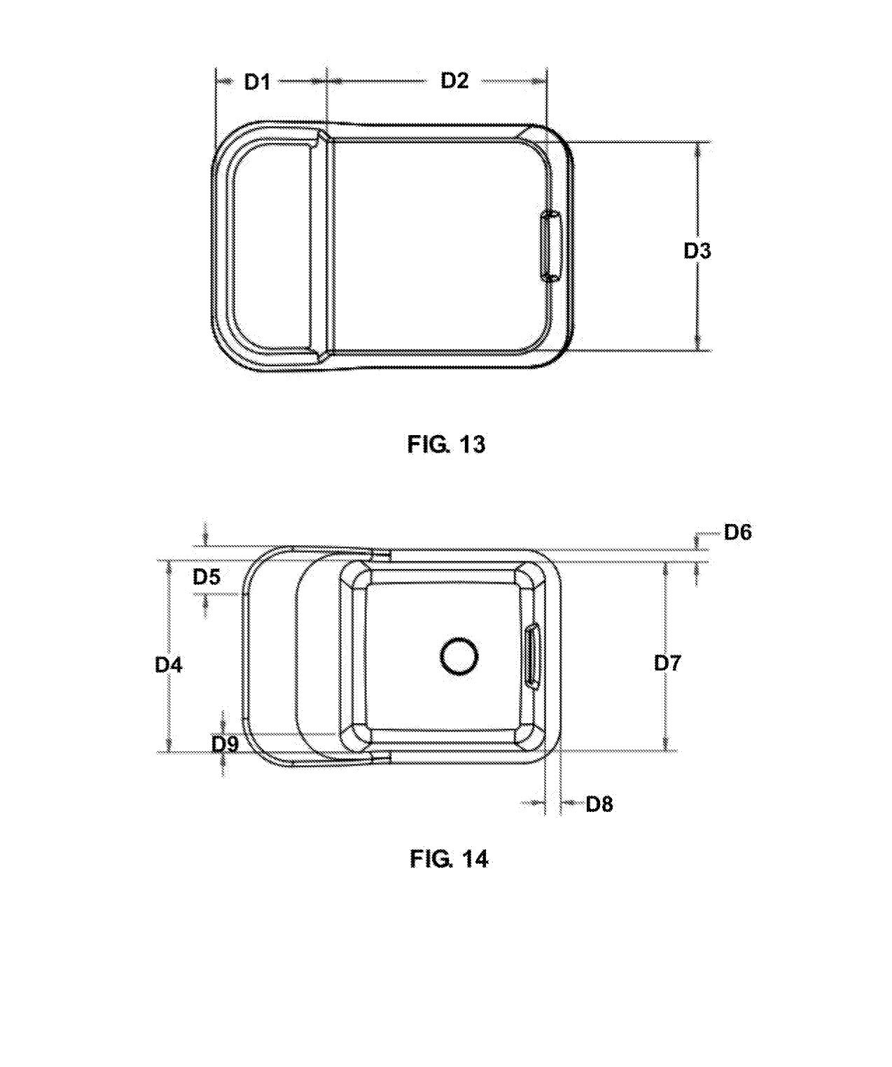

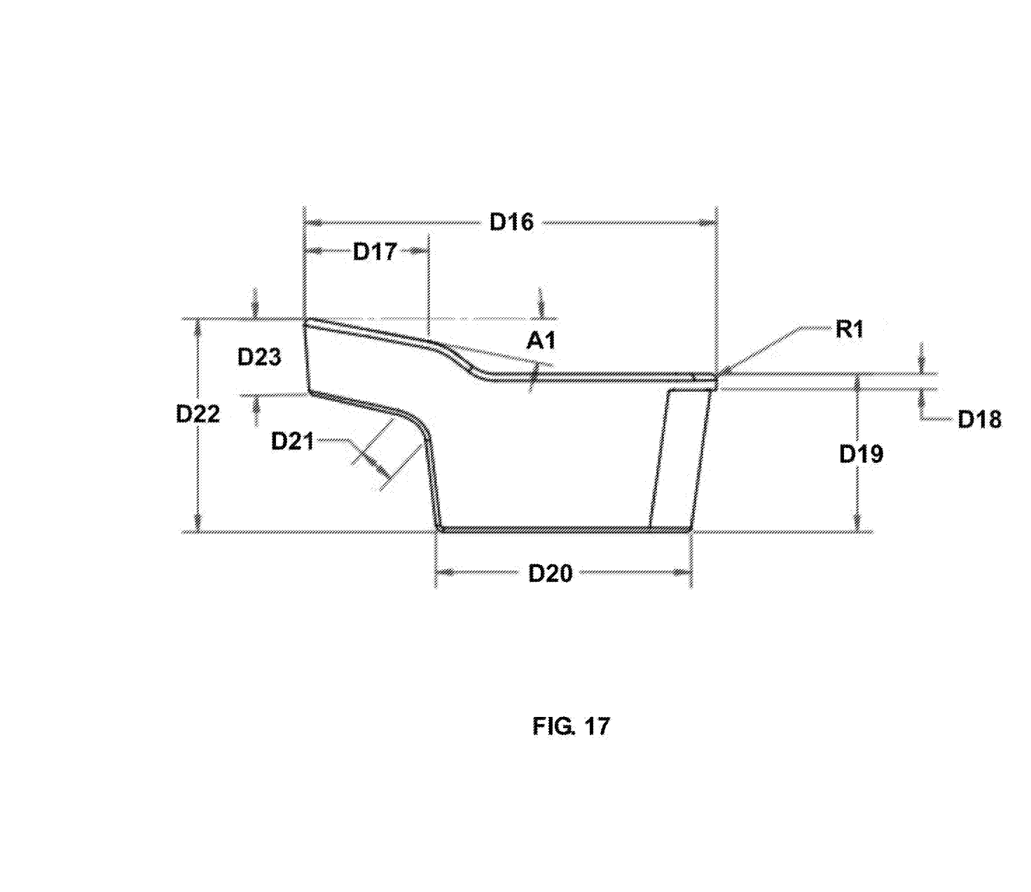

In a first non-limiting example, a sink 10 is provided with the dimensions as shown in FIGS. 13-17 and described below:

D1: about 20.9 cm (about 8.24 inches);

D2: about 41.4 cm (about 16.29 inches);

D3: about 39.34 cm (about 15.49 inches);

D4: about 41.1 cm (about 16.16 inches);

D5: about 10.2 cm (about 4.02 inches);

D6: about 2.59 cm (about 1.02 inches);

D7: about 40.5 cm (about 15.93 inches);

D8: about 3.35 cm (about 1.32 inches);

D9: about 3.89 cm (about 1.53 inches);

D10: about 15.3 cm (about 6.01 inches);

D11: about 10.2 cm (about 4.00 inches);

D12: about 10.9 cm (about 4.28 inches);

D13: about 47.1 cm (about 18.53 inches);

D14: about 35.2 cm (about 13.84 inches);

D15: about 40.9 cm (about 16.09 inches);

D16: about 68.0 cm (about 26.77 inches);

D17: about 20.5 cm (about 8.05 inches);

D18: about 2.54 cm (about 1.00 inches);

D19: about 26.0 cm (about 10.25 inches);

D20: about 42.1 cm (about 16.59 inches);

D21: about 6.30 cm (about 2.48 inches);

D22: about 35.1 cm (about 13.83 inches);

D23: about 12.5 cm (about 4.94 inches);

R1: Radius of curve of about 40.00;

A1: about 11.00 degrees.

Persons of ordinary skill in the art will recognize that many modifications may be made to the present application without departing from the spirit and scope of the application. The embodiment(s) described herein are meant to be illustrative only and should not be taken as limiting the invention, which is defined in the claims.

I claim:

1. A pedicure sink including a basin having a fluid flow surface extending from within the basin out apart from the basin in a continuous manner, wherein at least part of the fluid flow surface provides a support surface for target feet.

2. The pedicure sink of claim 1 wherein the basin includes an inner surface and wherein the fluid flow surface includes at least part of the inner surface of the basin.

3. The pedicure sink of claim 1 wherein the part of the fluid flow surface providing a support surface for target fee is operationally configured to capture fluid and direct captured fluid into the basin.

4. The pedicure sink of claim 1 wherein the basin includes an upper perimeter surface and wherein at least part of the fluid flow surface providing a support surface for target fee is located at an elevation greater than the upper perimeter surface.

5. A pedicure sink, including:
a basin defined by an upper perimeter; and
a target feet support surface extending out from the basin in a manner effective to direct fluid collected thereon into the basin via gravity, wherein the target feet support surface is located at an elevation greater than the upper perimeter of the basin.

6. The pedicure sink of claim 5 wherein part of the upper perimeter of the basin is defined by a transitional surface disposed between an inner surface of the basin and the target feet support surface.

7. A pedicure spa including a pedicure sink and a body operationally configured to support the pedicure sink thereon, wherein the pedicure sink includes a basin having a fluid flow surface extending from within the basin out apart from the basin in a continuous manner, wherein at least part of the fluid flow surface provides a support surface for target feet.

8. The pedicure spa of claim 7 wherein the body includes one or more support members.
